(19) United States
(12) Patent Application Publication
(10) Pub. No.: US 2025/0059666 A1
(43) Pub. Date: Feb. 20, 2025

(54) MICROPOROUS SHEET AND METHOD FOR FABRICATING THE SAME

(71) Applicant: HCMed Innovations Co., LTD., Taipei City (TW)

(72) Inventors: CHANG-HSIEH YAO, Taipei City (TW); HSUN-WEI CHIANG, Taoyuan City (TW)

(21) Appl. No.: 18/411,212

(22) Filed: Jan. 12, 2024

(30) Foreign Application Priority Data
Aug. 17, 2023 (CN) 202311033875.7

(51) Int. Cl. C25D 1/08; C25D 1/20

(52) U.S. Cl. CPC C25D 1/08; C25D 1/20

(57) ABSTRACT

A microporous sheet and a method for fabricating the same are provided. The method includes: providing a substrate; forming a pattern layer on the substrate; depositing a metal layer on the pattern layer through an electroforming process, in which the metal layer includes a dummy metal sheet and a plurality of microporous sheets, and each of the microporous sheets is connected to the dummy metal sheet through at least one connection structure; and peeling off the metal layer from the substrate, and removing the microporous sheets from the metal layer.

### CROSS-REFERENCE TO RELATED PATENT APPLICATION

This application claims the benefit of priority to China Patent Application No. 202311033875.7, filed on Aug. 17, 2023 in People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a component and a method for fabricating the same, and more particularly to a microporous sheet and a method for fabricating the same.

### BACKGROUND OF THE DISCLOSURE

A nebulizer atomizes medicinal liquid through an internal atomization module to form and spray aerosols. A microporous sheet inside the atomization module vibrates to convert the medicinal liquid into the aerosols with tiny droplets by powering a piezoelectric component of the atomization module.

The mass-production of microporous sheets through the existing process involves taking out a large quantity of microporous sheets that are weakly attached to the metal sheet. Various fracture structures with different protrusions and warping deformations may be formed on an edge during the removal of the microporous sheet. Such a fractured structure will affect an alignment accuracy in a lamination process of a subsequent manufacture process of the atomization module, which can seriously affect an accuracy of products. Due to the fractured structure, the fabricated atomization module may be warped and deformed at certain locations where it cannot be sealed tightly and result in moisture leakage issues.

Therefore, improving the process of the microporous sheet to ensure a uniformity of the fracture structure to address the alignment and leakage issues has become one of the important issues in the relevant art.

### SUMMARY OF THE DISCLOSURE

In response to the above-referenced technical inadequacies, the present disclosure provides a microporous sheet and a method for fabricating the same, processing steps of which are simplified and capable of addressing alignment issues during the attachment of the atomizing module.

In order to solve the above-mentioned problems, one of the technical aspects adopted by the present disclosure is to provide a method for fabricating microporous sheets, and the method includes: providing a substrate; forming a pattern layer on the substrate; depositing a metal layer on the pattern layer through an electroforming process, in which the metal layer includes a dummy metal sheet and a plurality of microporous sheets, the microporous sheets are spaced apart from each other within the dummy metal sheet, and each of the microporous sheets is connected to the dummy metal sheet through at least one connection structure; and peeling off the metal layer from the substrate, and removing the microporous sheets from the metal layer.

In order to solve the above-mentioned problems, another one of the technical aspects adopted by the present disclosure is to provide a microporous sheet, which includes a metal plate having a first surface and a second surface. The metal plate includes a main region provided with a plurality of micropores penetrating through the first surface and the second surface of the metal plate, and an outer region surrounding the main region. The outer region has a plurality of cut-off openings disposed around the main region, and each of the cut-off openings is recessed from a periphery of the outer region toward the main region, so as to present a concave shape relative to the outer region.

Therefore, in the microporous sheet and the method for fabricating the same provided by the present disclosure, the shape and size of each microporous sheet and connection points can be precisely defined by electroforming to maintain consistency, each microporous sheet can also be quickly peeled off from the entire metal layer by a rod-shaped tool corresponding to the outer region of the microporous sheet without performing additional punching or cutting procedures.

On the other hand, in the microporous sheet and the method for fabricating the same provided by the present disclosure, a joint surface with a concave shape and relatively small thickness is designed at a connection structure between the outer region of the microporous sheet and the dummy metal sheet, such that a fracture surface can be restricted to be formed at the joint surface when the microporous sheet is removed. Further, the concave and consistent fracture surfaces can avoid alignment issues during the bonding stage caused by the fracture structures in the existing process, and can address moisture leakage issues caused by warpages and deformations of the fractured structure for the manufactured atomization module.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for fabricating microporous sheets according to one embodiment of the present disclosure;

FIG. 2 is a schematic top view of a substrate and a pattern layer according to one embodiment of the present disclosure

FIG. 3 is an enlarged schematic view of part III of FIG. 2.

FIG. 4 is an enlarged schematic view of part IV of FIG. 3;

FIG. 5 is a schematic partial top view showing a metal layer being disposed on the pattern layer using an electroforming process according to one embodiment of the present disclosure; and

FIG. 6 is a schematic top view of a microporous sheet according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

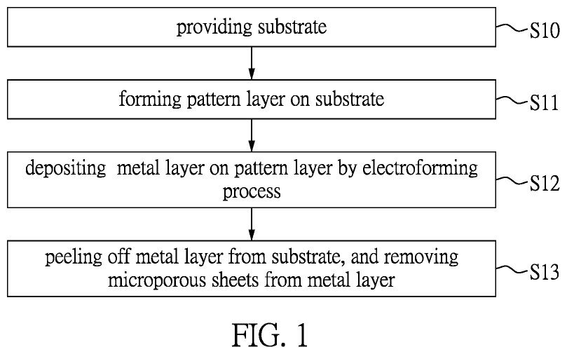

FIG. 1 is a flowchart of a method for fabricating microporous sheets according to one embodiment of the present disclosure. Referring to FIG. 1, one embodiment of the present disclosure provides a method for fabricating microporous sheets, which includes the following steps:

Step S10: providing a substrate. The substrate can, for example, be made of a conductive material, such as a conductive metal (e.g., copper), or a semiconductor material such as silicon.

Step S11: forming a pattern layer on the substrate.

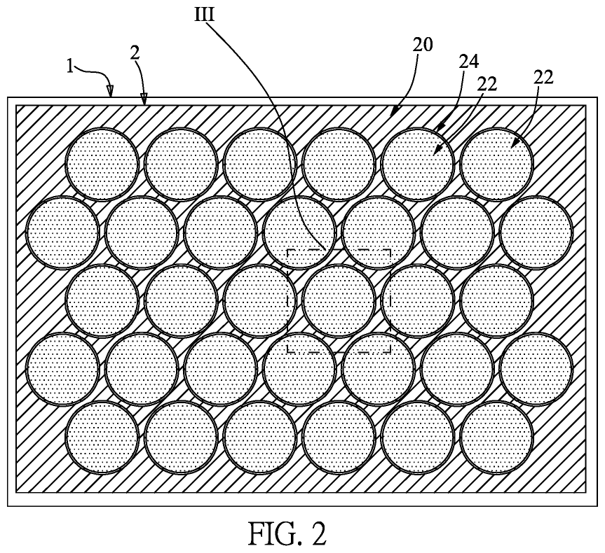

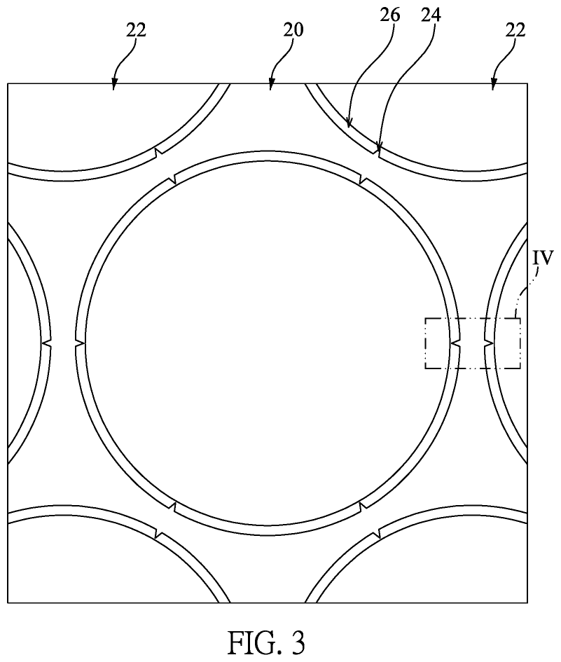

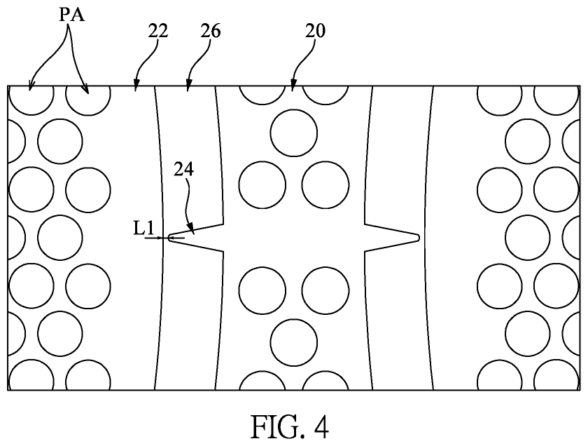

Reference is made to FIGS. 2 to 4, in which FIG. 2 is a schematic top view of a substrate and a pattern layer according to one embodiment of the present disclosure, FIG. 3 is an enlarged schematic view of part III of FIG. 2, and FIG. 4 is an enlarged schematic view of part IV of FIG. 3. As shown in FIG. 2, the pattern layer 2 can be formed on the substrate 1 through a photolithography process. Specifically, in the photolithography process, patterns on a mask can be transferred to the substrate 1 in a form of a photoresist layer by steps such as exposure and developing, thereby forming the pattern layer 2. However, the above method for forming the pattern layer 2 is merely an example, and the pattern layer 2 can also be formed by other processes, and the present disclosure is not limited thereto.

In addition, in one embodiment of the present disclosure, a dummy area 20 and a plurality of microporous sheet areas 22 are defined in the pattern layer 2. Specifically, the microporous sheet areas 22 are areas where multiple microporous sheets are intended to be formed, and the dummy area 20 is a redundant area that is not used to form the microporous sheets. As shown in FIG. 2, the microporous sheet regions 22 are spaced apart from one another within the dummy area 20, and each of the microporous sheet areas 22 is adjacent to the dummy region 20 through connection patterns 24. In more detail, a hollow area 26 is provided between the microporous sheet areas 22 and the dummy area 20, the connection patterns 24 are located in the hollow area 26, and each of the connection patterns 24 extends from the dummy area 20 toward the closest microporous sheet area 22 without contacting the closest microporous sheet area 22. That is, each of the connection pattern 24 is separated from the microporous sheet area 22 by at least a predetermined distance L1. The difference between the hollow area 26 and the dummy area 20 is that the metal layer will be formed in the dummy area 20 in the subsequent processes, while the hollow area 26 is used to reserve a space for forming an outer region of each of microporous sheets.

It should be noted that, at least one corresponding connection pattern 24 is provided for each of the microporous sheet areas 22. Therefore, after the microporous sheet is formed, the connection pattern 24 can be used to form at least one connection structure for weakly attaching the microporous sheet to the metal layer corresponding to the dummy area 20. Therefore, it is necessary to properly design a quantity and locations of the connection patterns 24 corresponding to each microporous sheet area 22, so as to ensure that the microporous sheet can be completely taken off as a whole.

On the other hand, as shown in FIG. 4, a plurality of pore areas PA are formed in each of the microporous sheet areas 22 for forming micropores in the microporous sheet. In addition, in order to ensure stress balance of the metal layer, multiple pore areas PA are also provided in the dummy area 20 to avoid warpage during the formation of the metal layer. In general, in step S11, photoresist is formed in the pore areas PA and the hollow area 26 of the pattern layer 2, and defines the dummy area 20, the microporous sheet areas 22, and the connection patterns 24 through the pore areas PA and the hollow area 26. That is, portions of the substrate 1 corresponding to the dummy area 20, the microporous sheet areas 22, and the connection patterns 24 are exposed.

Step S12: depositing a metal layer on the pattern layer by an electroforming process.

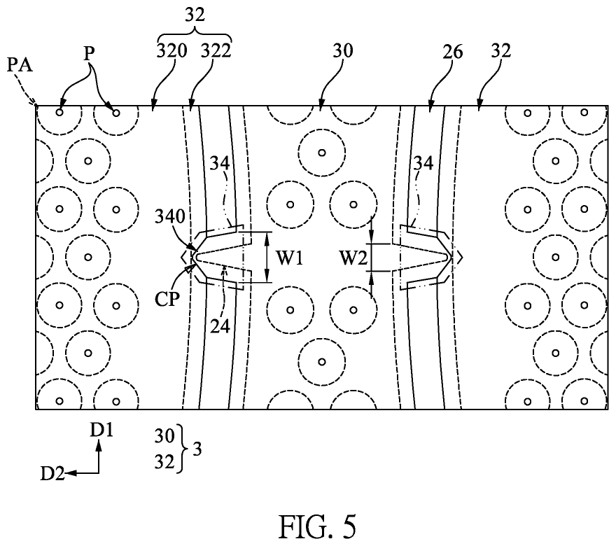

Reference is made to FIG. 5, which is a schematic partial top view showing the metal layer being disposed on the pattern layer using the electroforming process according to one embodiment of the present disclosure. As shown in FIG. 5, the electroforming process uses electroplating to deposit a specific type of metal on a specially designed pattern layer 2, and the formation of the metal layer 3 is completed after being deposited to a certain thickness and separated from the substrate 1 and the pattern layer 2. Shapes and sizes of each microporous sheet and each connection structure in the metal layer 3 can be precisely defined by electroforming to maintain consistency.

In step S12, the metal layer 3 can be made of palladium-nickel alloy, for example, and the metal layer 3 can include a dummy metal sheet 30 and a plurality of microporous sheets 32. The microporous sheets 32 are arranged within the dummy metal sheet 30 and spaced apart from one another, and each of the microporous sheets 32 is connected to the dummy metal sheet 30 through the connection structures 34. Since the metal layer 3 is deposited from an area on the substrate 1 that is not covered by the pattern layer 2, the dummy metal sheet 30 is formed corresponding to the dummy area 20, the microporous sheets 32 are formed to corresponding to the microporous sheets, respectively, and the connection structures 22 are formed to corresponding the connection patterns 24.

Each of the microporous sheets 32 includes a main region 320 and an outer region 322 surrounding the main region 320, and the main region 320 has dispersed micropores P spaced apart from one another therewithin. Each of the connection structure 34 extends from the dummy metal sheet 30 toward the corresponding microporous sheet 32, and has a connecting tip 340 connected to the outer region 322 of the corresponding microporous sheet 32.

As described above, after the microporous sheet 32 is formed, at least one corresponding connection structure 34 is required to make the microporous sheet 32 weakly attached to the dummy metal sheet 30. Therefore, a quantity and locations of the connection patterns 34 corresponding to each microporous sheet 32 can be properly designed, so as to ensure that when the metal layer 3 is peeled off from the substrate 1 and the pattern layer 2, the dummy metal sheet 30 and the microporous sheets 32 can be completely taken off, and the microporous sheets 32 is still bonded to the dummy metal sheet 30 with the connection structures 34.

In addition, as shown in FIG. 5, the connection structures 34 may be arranged symmetrically. More precisely, the connection structures 34 can be arranged symmetrically with respect to a part of the dummy metal sheet 30 between two adjacent connection structures 34. Moreover, the connection structures 34 can be located between two adjacent microporous sheets 32. The microporous sheet 32 can, for example, be circular with a radius ranging from 2 mm to 5 mm. A width of the outer region 322 is much smaller than a radius of the main region 320, and can range from 20 μm to 50 μm.

In order to obtain a regular fracture surface for the microporous sheet 32 after being removed, a connection between the connection structure 34 and the corresponding outer region 322 is provided with a joint surface CP. The joint surface CP is recessed from the dummy metal sheet 30 toward the microporous sheet 32 (i.e., a direction D2 in a case of the microporous sheet 32 on the left side of FIG. 5), so as to present a concave shape relative to the outer region 322. The joint surface CP is designed to provide a position at which a structural strength is significantly weaker than that of an area surrounding the joint surface CP, such that when an external force is applied to the microporous sheet 32 or the dummy metal sheet 30 and transmitted to the joint surface CP, stress will concentrate on the joint surface CP, which tends to form a fracture surface that is similar to the joint surface CP in shape and position. For this reason, a thickness of the joint surface CP needs to be smaller than a thickness of the connection structure 34 or a thickness of the outer region 322.

Considering the deposition of the metal layer 3 in the electroforming process, a part of the outer region 322 corresponding to the connection structure 34 can be designed as an arc portion or a tapered portion, for example. A bottom surface (i.e., the joint surface CP) of the arc portion or the tapered portion is located at an inner edge of the outer region 322 adjacent to the main region 320. In other words, there is another distance between the joint surface CP and the main region 320.

In order to maintain a consistent fracture surface following the detachment of the microporous sheet 32, a morphology of the connection structure 34 needs to be further designed. Firstly, the connection structure 34 needs to have a shape complementary to the joint surface CP (i.e., the arc portion or the tapered portion). Furthermore, to ensure that the connection structure 34 has a higher structural strength on a side close to the dummy metal sheet 30 and a lower structural strength on a side close to the microporous sheet 32, the connection structure 34 has a first width W1 in a direction D1, and the first width W1 gradually changes from the dummy metal sheet 30 toward the direction D2 of the corresponding microporous sheet 32, or more specifically, gradually decreases. In this way, the connection structure 32 can be easily broken from the side close to the microporous sheet 32 when subjected to an external force, so as to firstly ensure a regularity of the position of the fractured surface.

Therefore, the connection pattern 24 used in step S11 needs to be considered together with the morphology of the connection structure 34 formed subsequently. Therefore, the connection pattern 24 can be designed to have a second width W2 in the direction D1. Similar to the first width W1, the second width W2 also gradually changes from the dummy region 20 toward a direction of the corresponding microporous sheet region 22, or more specifically, the second width W2 gradually decreases, and is smaller than the first width W1.

Therefore, when the metal layer 3 is formed in step S12, only thinner parts of the metal layer 3 will be formed in areas provided with photoresist (i.e., the pore areas PA and the hollow area 26). Therefore, the outer region 322 with a thickness larger than that of the main region 320 will be formed between the dummy area 20 and the microporous sheet areas 22, and the joint surface CP with a thickness smaller than the thicknesses of the connection structures 34 and the outer region 322 will be formed between the connection pattern 24 and the microporous sheet area 22. The structural strength of the joint surface CP is significantly weaker than those of the surroundings.

Step S13: peeling off the metal layer from the substrate, and removing the microporous sheets from the metal layer.

In this step, after the metal layer 3 is peeled off from the substrate 1, a specially designed stripping tool can be used, on which a rod-shaped structure corresponding to the outer region 322 of the microporous sheet 32 is provided, such that each of the microporous sheets 32 can be quickly peeled off from the metal layer 3. Therefore, no additional punching or cutting process is required, thereby saving costs.

As previously described, since the joint surface CP with the structural strength significantly weaker than that of the surroundings, when an external force is applied to the microporous sheet 32 and transmitted to the joint surface CP, stress will concentrate on the joint surface CP to form a fracture surface that is similar to the joint surface CP in shape and position.

In addition, compared with the existing manufacturing methods, which are easy to form various fracture structures with different degrees of convexity on an edge of the microporous sheet, the method for fabricating the microporous sheets provided by the present disclosure can provide fracture surfaces have regularities in positions and shapes, such that the fracture surfaces can assist in improving alignment accuracy and address moisture leakage issues for the manufactured atomization module.

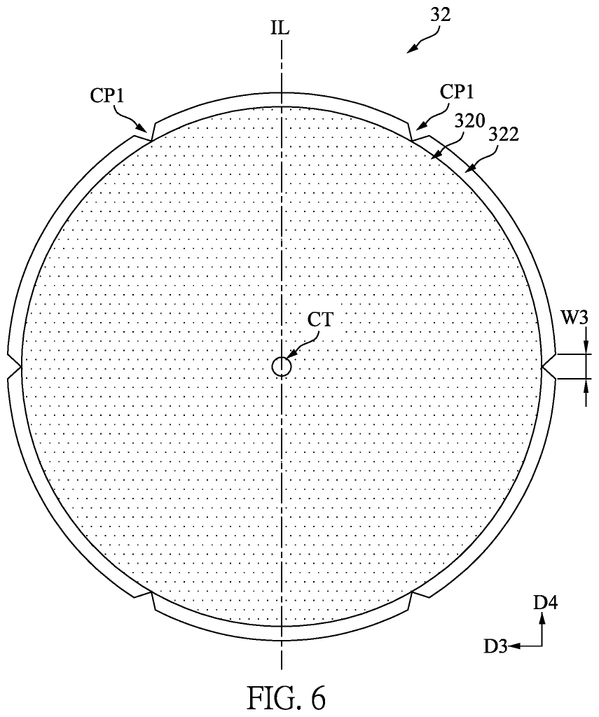

Reference is made to FIG. 6, which is a schematic top view of a microporous sheet according to one embodiment of the present disclosure. As previously described, the microporous sheet 32 is a metal plate formed by the metal layer 3, and has a first surface (upper surface) and a second surface (lower surface). The metal plate also includes a main region 320 and an outer region 322. The main region 320 is provided with a plurality of micropores P penetrating through the metal plate. The outer region 322 surrounds the main region 320, and has a plurality of cut-off openings CP1 disposed around the main region 320.

In detail, in step S13, when each of the microporous sheets 32 is separated from the dummy metal sheet 30 at the joint surface CP, the cut-off openings CP1 that are recessed from the outside of the outer region 322 toward the main region 320 are formed, and each of the cut-off openings CP1 presents a concave shape relative to the outer region 322.

Corresponding to the joint surface CP, the cut-off opening CP1 also has a structure that gradually changes. For example, the rightmost cut-off opening CP1 in FIG. 6 can have a width W3 in a tangential direction (i.e., direction D4), and the width W3 gradually decreases from the outside of the outer region 322 toward the direction D3 of the main region 320 (i.e., a radial direction).

In addition, corresponding to quantities and positions of the connection patterns 24, the connection structures 34 and the bonding surfaces CP, the cut-off openings CP1 can be radially or symmetrically arranged around a central point CT of the main region 320. For example, when a quantity of the cut-off openings CP1 is 6, the positions of the cut-off openings CP1 can be evenly distributed within 360 degrees (i.e., with an interval angle of 60 degrees), and the cut-off openings CP1 can be arranged on the outer region 322 symmetrically with respect to an imaginary axis IL passing through the central point CT. The cut-off openings CP1 arranged in a specific rule will assist in the positioning and alignment of the microporous sheet 32 in subsequent bonding processes used to manufacture the atomization module.

### Beneficial Effects of the Embodiments

In conclusion, in the microporous sheet and the method for fabricating the same provided by the present disclosure, the shape and size of each microporous sheet and connection points can be precisely defined by electroforming to maintain consistency, and each microporous sheet can also be quickly peeled off from the entire metal layer by a rod-shaped tool corresponding to the outer region of the microporous sheet without performing additional punching or cutting procedures.

On the other hand, in the microporous sheet and the method for fabricating the same provided by the present disclosure, a joint surface with a concave shape and relatively small thickness is designed at a connection structure between the outer region of the microporous sheet and the dummy metal sheet, such that a fracture surface can be restricted to be formed at the joint surface when the microporous sheet is removed. Further, the concave and consistent fracture surfaces can avoid alignment issues during the bonding stage caused by the fracture structures in the existing process, and can address moisture leakage issues caused by warpages and deformations of the fractured structure for the manufactured atomization module.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

1. A method for fabricating microporous sheets, the method comprising:
providing a substrate;
forming a pattern layer on the substrate;
depositing a metal layer on the pattern layer through an electroforming process, wherein the metal layer includes a dummy metal sheet and a plurality of microporous sheets, the microporous sheets are spaced apart from each other within the dummy metal sheet, and each of the microporous sheets is connected to the dummy metal sheet through at least one connection structure; and
peeling off the metal layer from the substrate, and removing the microporous sheets from the metal layer.

2. The method according to claim 1, wherein a dummy area and a plurality of microporous sheet areas are defined in the pattern layer, and the microporous sheet areas are spaced apart from each other within the dummy area, and each of the microporous sheet areas is adjacent to the dummy area through at least one connection pattern,
wherein the dummy metal sheet is formed corresponding to the dummy area, the microporous sheets are formed corresponding to the microporous sheet areas, and the at least one connection structure is formed corresponding to the at least one connection pattern.

3. The method according to claim 2, wherein each of the microporous sheets includes a main region and an outer region surrounding the main region, the at least one connection structure extends from the dummy metal sheet toward the corresponding microporous sheet, the at least one connection structure has a connection tip, and the outer region of each of the microporous sheets is connected to the corresponding connection tip.

4. The method according to claim 3, wherein any adjacent two of the connection structure are symmetrically arranged.

5. The method according to claim 3, wherein the at least one connection structure is located between two adjacent ones of the microporous sheets.

6. The method according to claim 3, wherein a connection between the at least one connection structure and the corresponding outer region is provided with a joint surface, and the joint surface is recessed from the dummy metal sheet toward the microporous sheet, so as to have a concaved shape relative to the outer region.

7. The method according to claim 6, wherein the at least one connection structure has a first width in a first direction, and the first width gradually decreases along a direction from the dummy metal sheet toward the corresponding microporous sheet.

8. The method according to claim 7, wherein the at least one connection pattern has a second width in the first direction, the second width gradually decreases along a direction from the dummy metal sheet toward the corresponding microporous sheet area, and the second width is less than the first width.

9. The method according to claim 6, wherein a part of the outer region corresponding to the at least one connection structure is an arc portion or a tapered portion, and a bottom surface of the arc portion or the tapered portion is located at an inner edge of the outer region adjacent to the main region.

10. The method according to claim 9, wherein the at least one connection structure has a shape complementary to the arc portion or the tapered portion.

11. The method according to claim 7, wherein a thickness of the joint surface is smaller than a thickness of the at least one connection structure or a thickness of the outer region.

12. The method according to claim 11, wherein, in the process of peeling off the metal layer from the substrate to obtain the microporous sheets, each of the microporous sheets is separated from the dummy metal sheet at the joint surface to form a cut-off opening.

13. The method according to claim 3, wherein each of the microporous sheets is circular, and has a radius ranging from 2 mm to 5 mm.

14. The method according to claim 3, wherein a width of the outer region ranges from 20 μm to 50 μm.

15. The method according to claim 2, wherein the at least one connection pattern extends from the dummy area toward a closest one of the microporous sheet areas without contacting the closest one of the microporous sheet areas.

16. A microporous sheet, comprising:
a metal plate having a first surface and a second surface, wherein the metal plate includes:
a main region provided with a plurality of micropores penetrating through the first surface and the second surface of the metal plate; and
an outer region surrounding the main region, wherein the outer region has a plurality of cut-off openings disposed around the main region,
wherein, each of the cut-off openings is recessed from a periphery of the outer region toward the main region, so as to have a concaved shape relative to the outer region.

17. The microporous sheet according to claim 16, wherein each of the cut-off openings has a width gradually decreased along a direction from the periphery of the outer diameter region toward the main region, and a thickness of the outer region is smaller than a thickness of the main region.

18. The microporous sheet according to claim 16, wherein the cut-off openings are radially or symmetrically arranged around a central point of the main region.

19. The microporous sheet according to claim 16, wherein the metal plate is circular, and has a radius ranging from 2 mm to 5 mm.

20. The microporous sheet according to claim 16, wherein a width of the outer region ranges from 20 μm to 50 μm.
